(19) United States
(12) Patent Application Publication
(10) Pub. No.: US 2017/0221333 A1
(43) Pub. Date: Aug. 3, 2017

(54) Integrated Child Safety Seat

(71) Applicants: David Gilbert Jackson, Welling, OK (US); George William Hess, Pensacola, FL (US)

(72) Inventors: David Gilbert Jackson, Welling, OK (US); George William Hess, Pensacola, FL (US)

(21) Appl. No.: 15/011,859

(22) Filed: Feb. 1, 2016

(51) Int. Cl. G08B 21/02; B60N 2/26; E05F 15/71; B60Q 5/00; B60R 21/015; B60Q 1/52; B60Q 1/26; B60N 2/00; E05F 15/73

(52) U.S. Cl. CPC G08B 21/02; B60N 2/002; B60N 2/26; E05F 15/71; E05F 15/73; B60R 21/01556; B60R 21/01516; B60Q 1/52; B60Q 1/2696; B60Q 5/005; E05Y 2400/30; E05Y 2400/44; E05Y 2400/52; E05Y 2900/55

(57) ABSTRACT

There is no known device which sounds an alarm and rolls down the windows in a car with a child left inside in a designed safety seat, when the temperature inside reaches an unsafe degree.

### CROSS-REFERENCE TO RELATED APPLICATIONS

“Not Applicable”

### STATEMENT REGUARDING FEDERALLY SPONSORED RESEARCH OR DEVELOPMENT

“Not Applicable”

### REFERENCE TO SEQUENCE LISTING

“Not Applicable”

### BACKGROUND OF INVENTION

The Integrated Child Safety Seat pertains to the field of physics and electronics to save the life of a child left in a closed vehicle. Control circuits were assembled and tested for different time delays needed for entry into a vehicle, allowing time to place supplies and seat a child. A summary from KIDS AND CARS.ORG states the following heat stroke deaths: 2015—child vehicular heat stroke deaths (as of; June; 2011—33 children; 2010—49 children; 2099—33 children. All of these deaths could have been avoided if there had been a safety seat invention installed in the vehicle.

### BRIEF SUMMARY OF THE INVENTION

The Integrated Child Safety Seat is designed to help save the life of a child/person(s) left in a vehicle, with the windows rolled up. This opportunity of receiving help is intended to keep a child/person from dieing from a heat stroke, etc., due to excessive exposure to high temperatures created by being left in a vehicle with the windows rolled up. After set amount of time, alerts/alarms are set off and the windows of the vehicle roll down, thus allowing some airflow for relief to the child/person(s) left in the vehicle.

An Article By: DENISE MANN at Web MD Archive

Every summer, heartbreaking and preventable deaths happen when children are left alone in hot cars. More than 600 U.S. children have died that way since 1990, according to the Nonprofit safety group KIDS and CARS.

Some parents may not want to take their child in and out of their cumbersome car seat for what they believe will be a quick stop. “ There is no safe amount of time to leave children alone in a car” says Nathan Allen, MD,

An emergency medicine doctors the University Chicago. “Kids are more susceptible and at higher risk for heat related illness and injury than adults because their bodies make more heat relative to their size and their abilities to cool through sweating are not as developed as adults. As a result, just a few minutes can be extremely dangerous even fatal for a small child.

Heat stroke may occur when body temperature passes 104 degrees Fahrenheit. that overwhelms the brains temperature control, causing symptoms such as dizziness, disorientation, agritation, confusion, sluggishness, loss of consciousness, and or death.

ON average, 38 children die in hot cars each year from heat related deaths after being trapped inside motor vehicles. Even the best of parents or caregivers can unknowingly leave a sleeping baby in a car and the end result can be injury or even death.

BELOW is a summery from KIDS AND CARS.ORG

In 2015 child vehicular heat stroke deaths as of Jun. 3, 2015 are 3

In 2014-31 children died from vehicular heat stroke.

In 2013-44 children, In 2012-33 children, In 2011-33 children,

In 2010-49 children, In 2009-33 children. All of these deaths could have been avoided. If there had been a safety seat invention installed in the vehicle.

The purpose of THE INTEGRATED CHILD SAFETY SEAT is to help spare the life of these children by an electronic invention.

Setting off of an alarm to draw attention of people in the area as well as having the Windows go down to allow airflow and access to the child in side the vehicle. This invention has two supply voltages. The first power supply is the twelve-volt battery main supply, the second supply comes from the ignition switch.

This alarm is activated first by the child seat switch (FIG. 10). This pressure switch consist of a circuit board with four tactical switches soldered on it the second board is mounted to the first board with springs to provide a pressure pad. This pressure switch can be placed in any child seat or cushion and can be parrell connected to as many as needed.

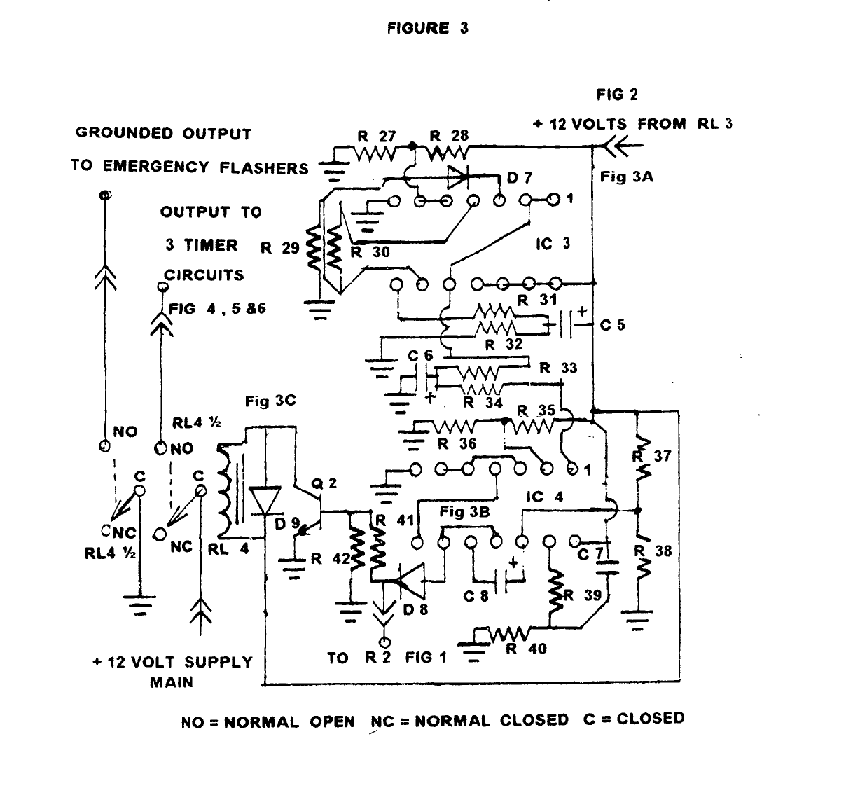

This pressure switch is placed between the cushion and the hard surface of the car seat. It provides a completion of the ground circuit the first relay (FIG. 2) allowing the power to the first timer circuit (FIG. 2)and also power for the emergency temperature backup circuit (FIG. 8). The first timer circuit is set after one minute fourteen seconds and remain armed for as long as the child remains in the seat. An indicator light will light showing that the circuit is armed.

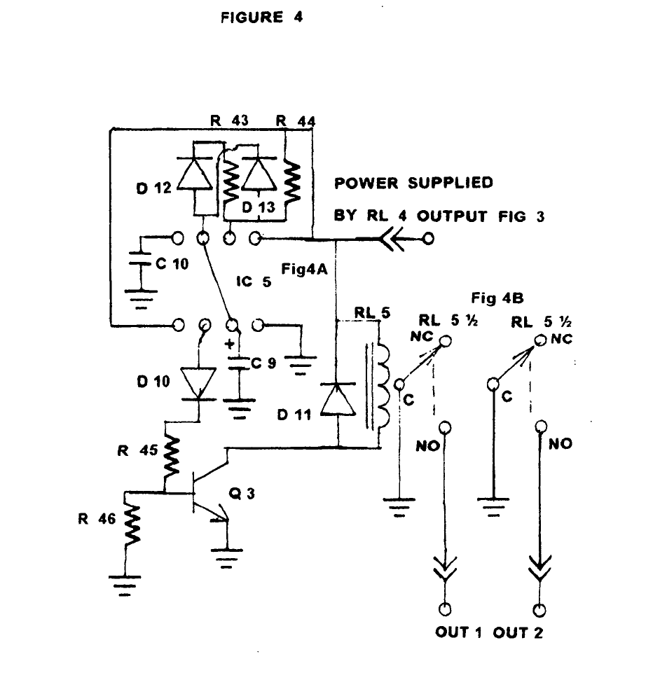

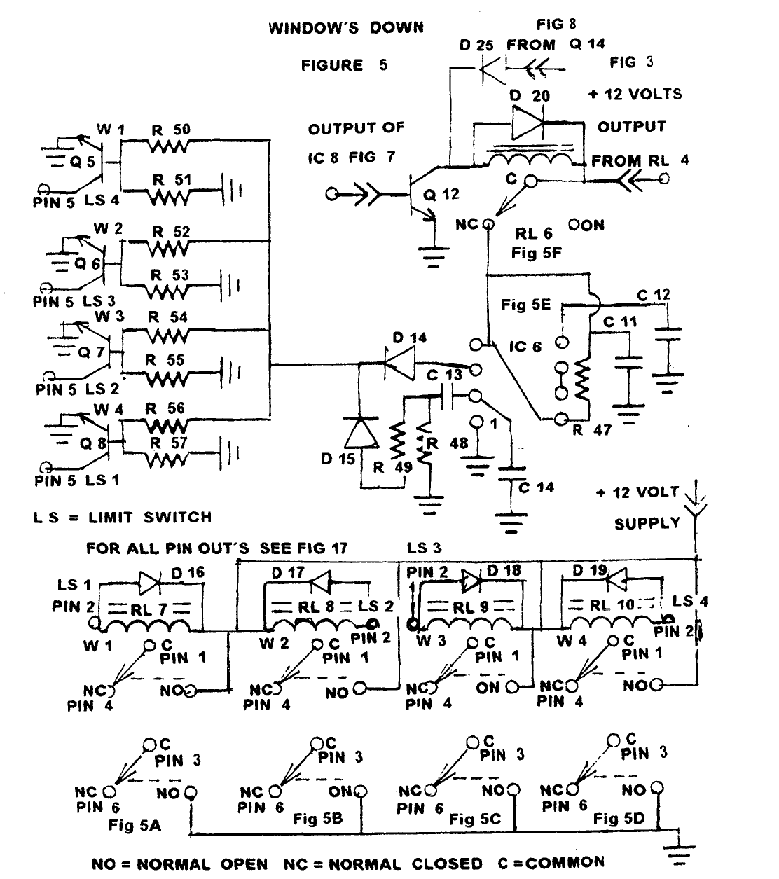

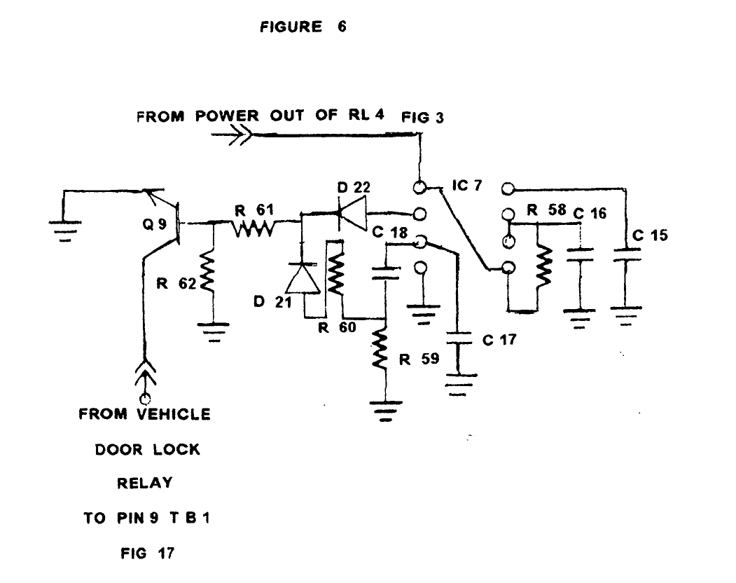

This will allow power to activate the second timer circuit provided that the doors are closed and the ignition switch has not been turned on. Turning on ignition will remove power to the second relay circuit. While the doors are open the magnetic proximity switches (FIGS. 12, 14 & 15) are open circuit this will not allow the third relay to close. These proximity switches are located (FIGS. 14 & 15) on the door post activated by magnets mounted on each door. The proximity switches are connected in series this is done so that any one of the doors will deactivate the second timer circuit (FIG. 3). Once the timer circuits have been active the lights will pulse flash and the horn will sound off. A pulse rate of two seconds on and two seconds off . All windows that are connected will roll down. The action of the windows down will allow fresh air to circulate and allow easy access to the child. The pulsing of the horns and flashing of the lights will continue until the child has been removed from the vehicle. After the windows are down they will not operate further downward because of the limit switches.

After the alarm unit has bee deactivated all functions will be restored to normal operation. If for any reason the ignition switch has been left on or a door is open or ajar the second timer circuit (FIG. 3) will not operate.

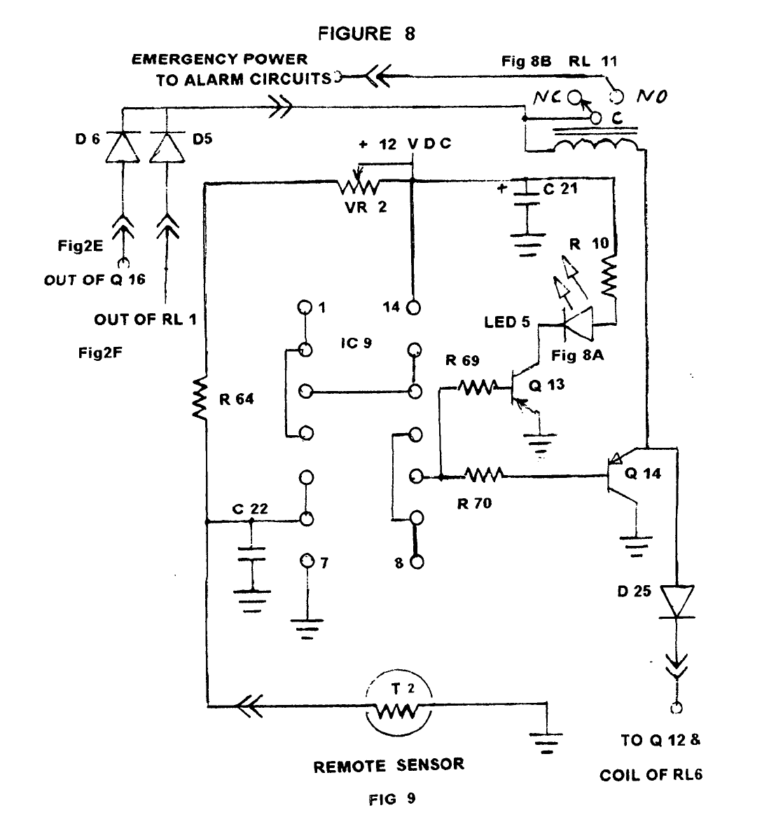

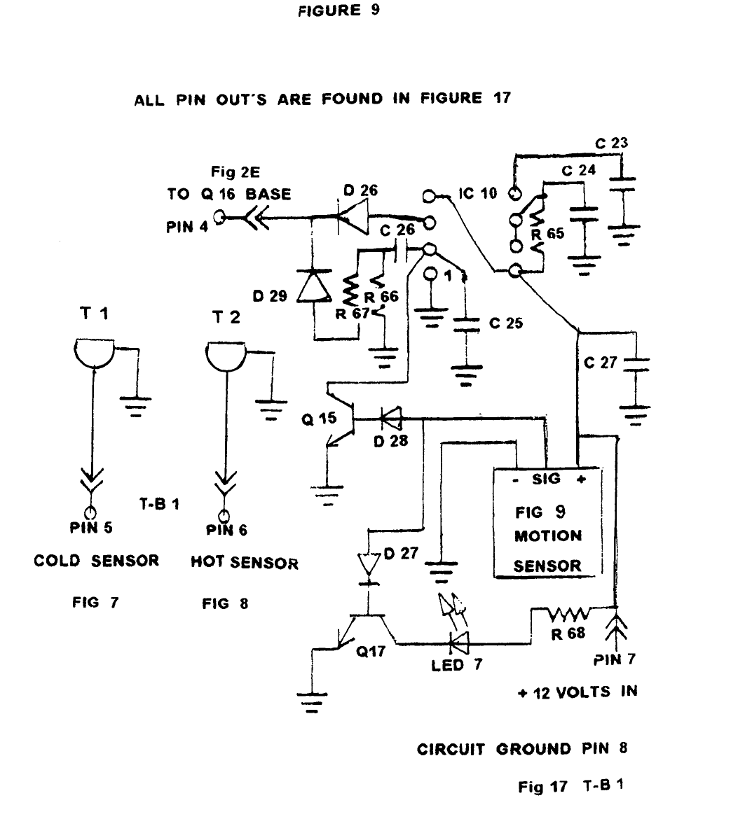

The thermal circuit will activate the alarm and roll down the windows. This Circuit (FIG. 8) is set for a temperature of plus 95 degrees Fahrenheit. This sensor T2 Thermistor (FIG. 9) is located in side the vehicle and provides a thermal backup to the system.

### DETAILED DESCRIPTION OF THE INVENTION:

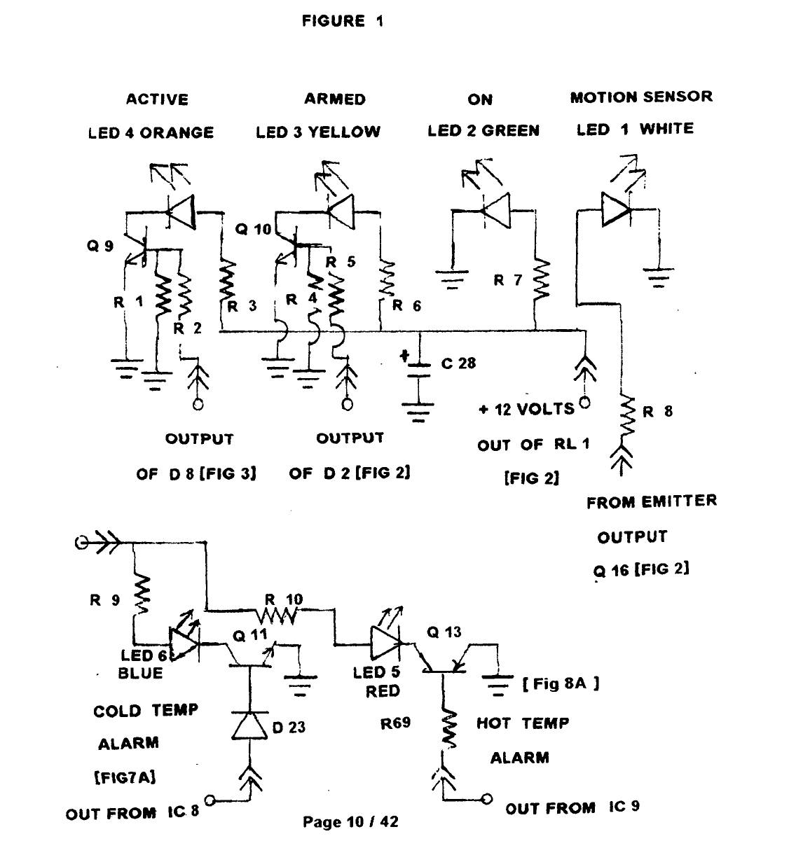

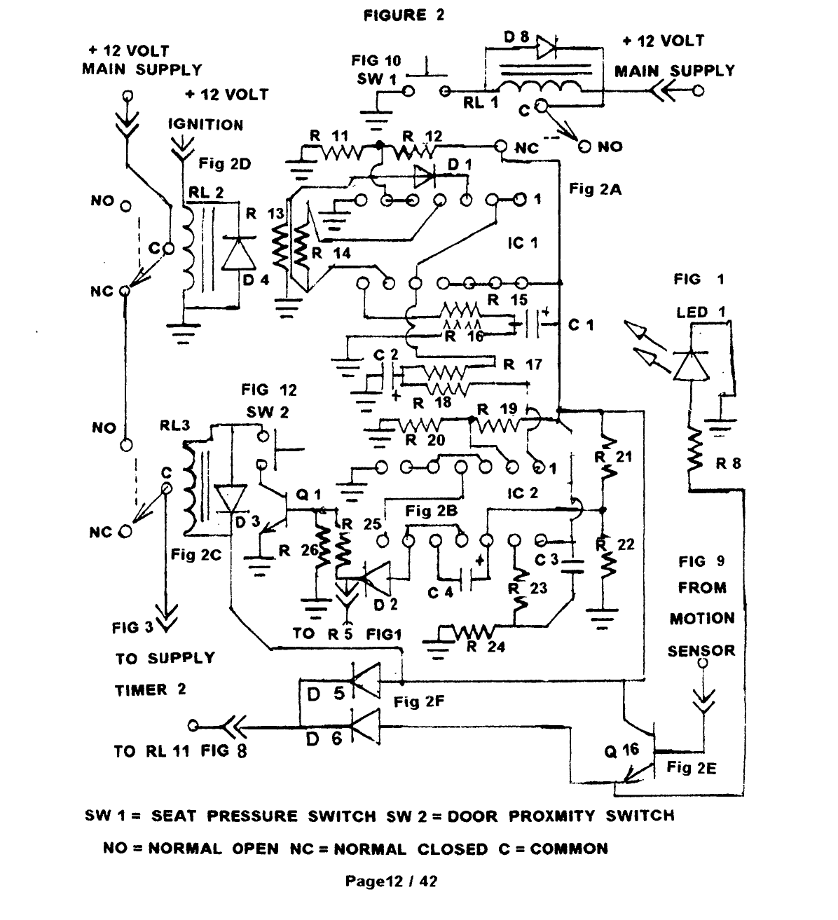

Placing a child in seat (FIG. 10) activates seat switch that completes relay 1 circuit. (FIG. 2A) This turns on the system shown by LED 2 (FIG. 1).Activating the first timer circuit (FIG. 2) IC 1 & IC 2. Counting down for 1 minute 40 seconds and remains on. Tested over 13 hours. LED 3 (FIG. 1) will then illuminate showing the circuit armed Q1 transistor circuit (FIG. 2C) the ground circuit for relay 3 is triggered but not until the door switches (FIGS. 12,14 & 15) are active, switches are magnetic proximity switches mounted in doorpost activated by a magnetic mounted on each door, (FIG. 14 &15) closing doors will trip switches on. This intern will allow the coil circuit on relay 3 (FIG. 2C) to work. Relay 2 supplies power to relay 3 while the vehicle ignition has not been turned on.

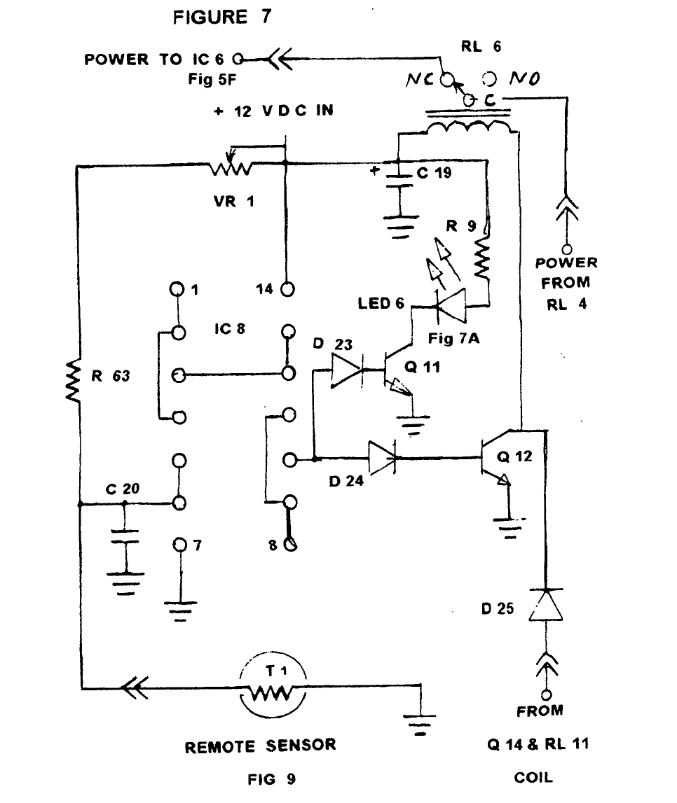

Turning on ignition will move contact from normal closed to normal open removing power. The ignition switch supplies power for the coil of relay 2 only. When vehicle ignition has been turned off and doors are closed and the child or person remains seated the system is still active (armed) relay 3 will pass power to the second timer circuit (FIG. 3) sequence IC3 & IC 4. This circuit will count down and trigger after a laps time of 20 seconds. Relay 4 will then be activate. The ground is achieved through Q 2 transistor circuit grounding coil circuit of relay 4. Lighting LED 4 (FIG. 1) system is triggered. Relay 4 is a double pole double throw relay. One half of this relay is a ground circuit for the emergency flashers, the other half controls power for timer circuits (FIGS. 4, 5 & 6). Pulse timer 2 seconds on 2 seconds off.

Another circuit (FIG. 5) is timed for 3 seconds allowing time to roll the windows down. Power going to relay 5 will trigger ground circuits on horn & parking lights accomplish by IC 5 timer and Q 3.

Power for windows down circuit travels through relay 6 to IC 6 (FIG. 5) this circuit controls relays 7, 8, 9 & 10 through wiring to windows. Pin outs are the same for all relays going to windows. This avoids confusion wiring windows

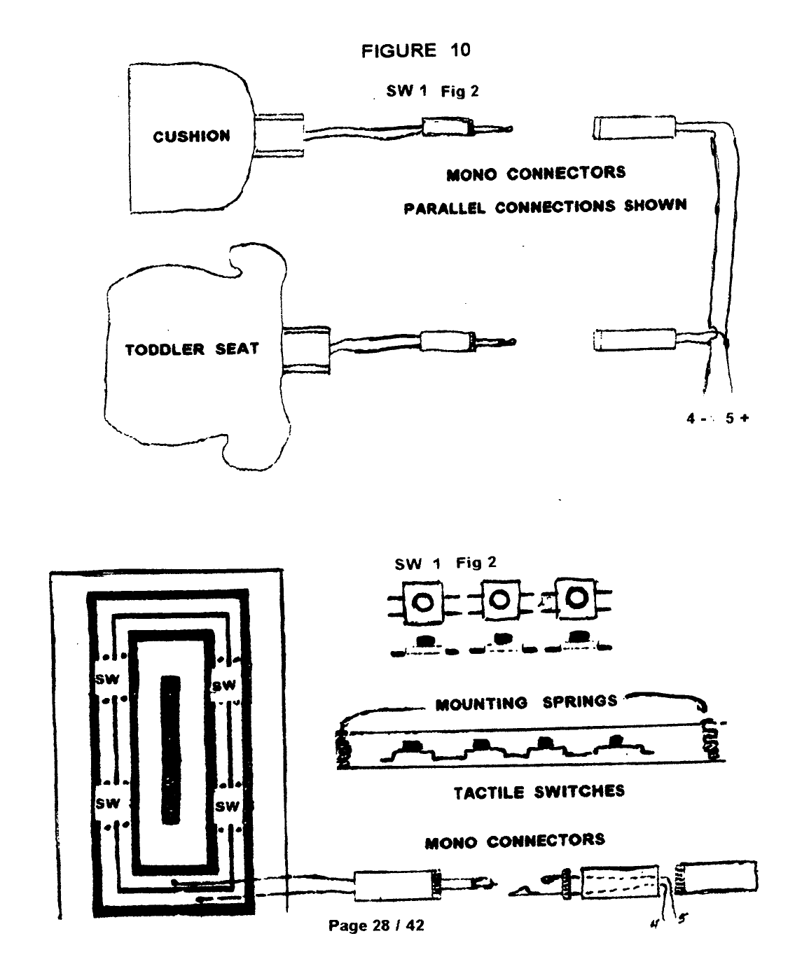

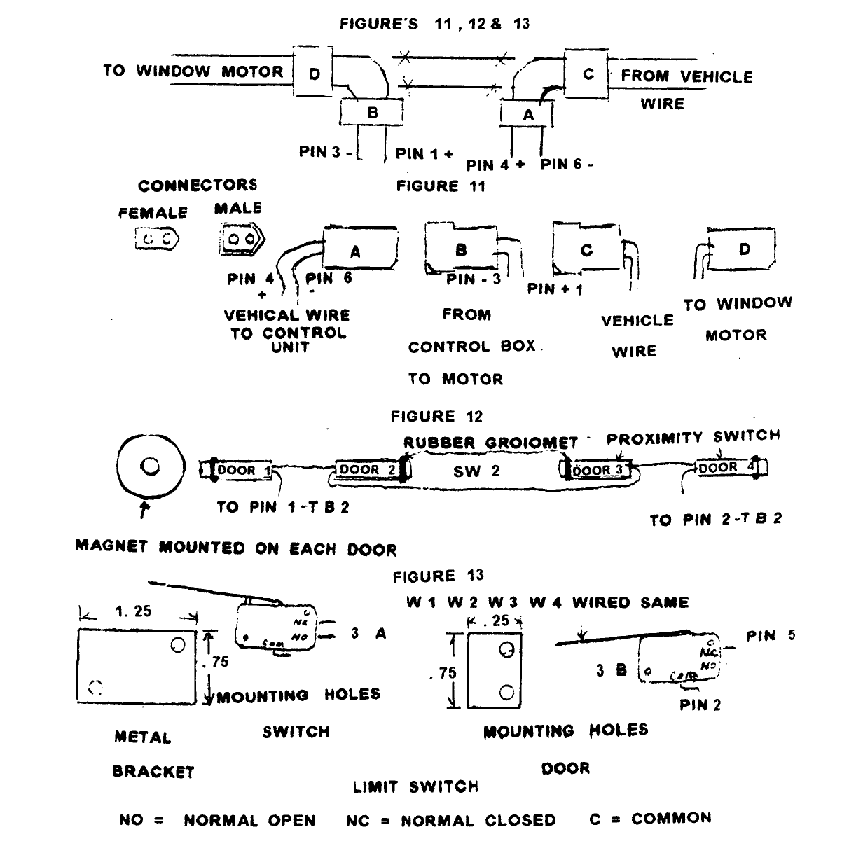

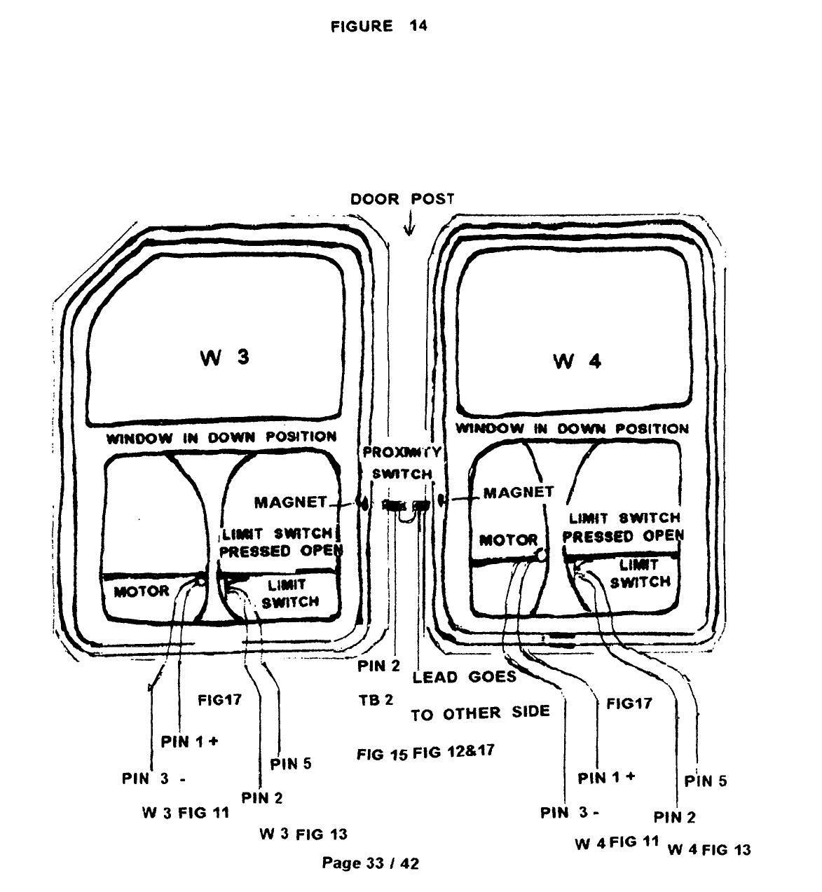

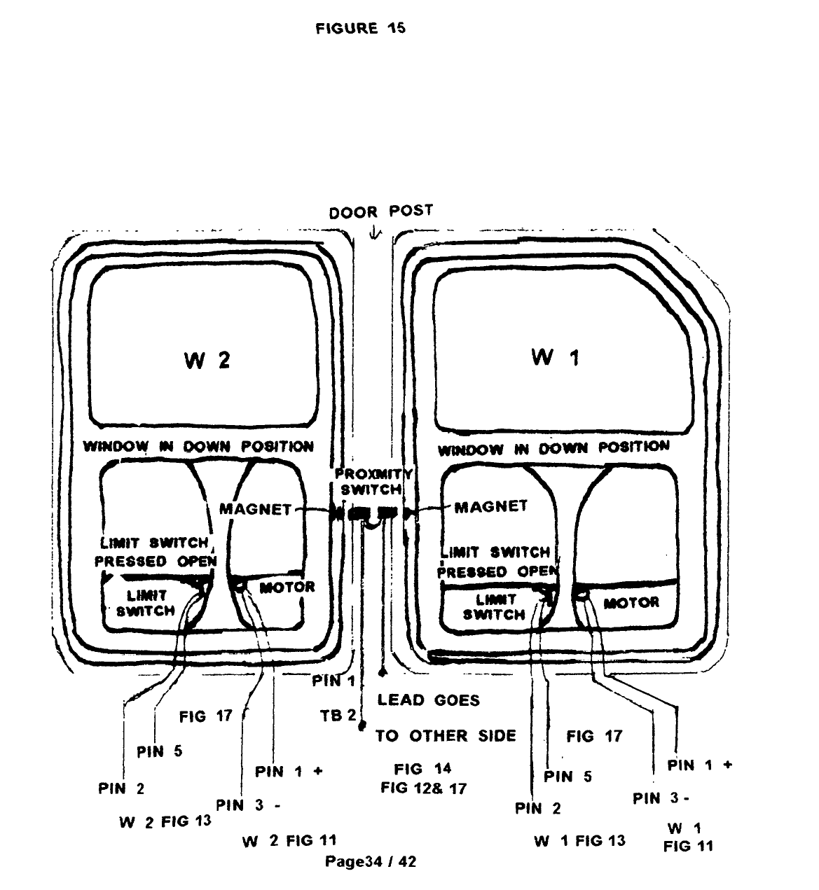

Interrupting factory wiring from vehicle (FIG. 11) to windows is necessary. Vehicle wire travels to relay normal closed terminals. Positive & negative polarities must be observed. Wire to motors comes from the common terminal (FIG. 5A, 5B, 5C & 5D). Wiring this way allows for normal operation while alarm circuit is not active. Power for windows will come from on board supply during operation (FIG. 5A, 5B, 5C& 5D).Limit switches FIG. 13 on doors (FIG. 14 & 15) controls ground circuits for each relay. Transistors Q 5, 6, 7 & 8 complete the ground circuits as long as the windows limit switches have not tripped. Limit switches are the protection for window motors (FIG. 13, 14 & 15). IC 8 is a temperature circuit that will activate (turn on) when the temperature goes below 45 degrees(FIG. 7). Turning on this circuit sends a signal to Q 12 (FIG. 5F) operating coil voltage at relay 6. This action will remove power going to IC6 shutting down the window circuit. Leaving the windows up at this time will protect the person in the vehicle from the cold temperature. At this time LED 6 a blue light (FIG. 1 & 7) lights up to alert cold temperature. Q 11 supplies the ground for LED 6. IC 9 through Q 13 is a heat active circuit (FIG. 8) LED 5 a red light lights to alert high temperature condition. At this time relay 11 is active through Q 14. This circuit is a thermal backup. Backup for excessive heat. Operating this circuit is protection for person left unattended and still seated in vehicle. A motion detector operates Q16 (FIG. 2) a power transistor that powers RL 11 through D6 (FIG. 8) during this operation. Operating only if alarm timer circuits have not been triggered. Temperature of this control circuit is set for 95 degrees. At this time the horn and light circuits will activate as well as the windows rolling down.

Connections: FIG. 17

Terminal block T 2 Pins # 1 & 2 are for the door proximity switch (FIG. 12,14 & 15) These switches are mounted at the doorpost and are connected in series one for each door. They operate using a magnet. When the door closes it closes the contacts on the switch. Pins 4 & 5 are terminals for the safety seat switches. FIG. 10 Pins 3 & 6 are spares. Pin 7 is the positive 12 volt terminal. Pin 8 is the ground terminal. Pin 9 is the positive 12 volt Ignition switch terminal.

Terminal block T 1 (FIG. 17) Pins 1 & 2 are for grounds to the existing relays headlights & horn found on the automotive fuse box. Terminals 1 & 2 pulse at a rate of 2 seconds on and 2 seconds off. Pin 3 is the ground circuit for the emergency lights. Relay of RL 4 (FIG. 3) circuit it is continuous allowing the action of the emergency flasher to operate. Pins 5 is terminal connection for the cold sensor. (FIG. 7). Pin 6 is terminal connection for the hot sensor. Pin 7 is the +12 volt supply for motion sensor. Pin 8 is ground for detectors. Pin 9 is the door lock terminal connection. Pins 10,11 & 12 are spares.

Terminal blocks W 1, 2,3 & 4 (FIG. 17) all these terminal blocks are wired the same. This allows wiring connection to the windows to be universal. Pin 1 is the positive common terminal connection to the window motor. Pin 3 is the negative common terminal connection for the window motor. Pins 2 & 5 are connections to the limit switch found mounted inside the door post (FIG. 14 & 15). Pin 4 is the positive connection traveling from the wire harness to Pin 1 of the control unit normally closed contact.

Pin 6 is the negative connection traveling from the wire harness to Pin 3 of the control unit normally closed contact. There is a possibility of adding additional devices. One may hook up as many as needed (FIG. 10). Simply connect by plugging into wiring harness any additional devices as needed. Hookups are all in parallel for safety seating to allow additional switch devises.
The Integrated Child Safety Seat Features
By David G Jackson

There is a possibility of adding additional devices you may hookup as many as needed. Simply connect by plugging in to wiring harness (FIG. 10) any additional devises as needed. Hookups are all in parrell. Proximity door switches are on each doorpost (FIG. 14 & 15) and activate when doors are closed. Proximity switches are magnetic operated (FIG. 12). All of these switches are connected in series. They operate relay 3 (FIG. 2) and through Q 1 which provides the ground path on that circuit. As a result it allows extra time to adjust seat for a child putting in extra supplies and seating your self behind the wheel. Initial start up is 1 minute 40 seconds to arm the first timer sequence. After this time you will have additional time until the doors are closed. When the doors are closed there is a 20 second delay before the alarm is triggered. This gives you plenty of time to start the vehicle before the alarm. For window operation there is a limit switch on each door (FIGS. 14 & 15) to operate the respective relay for that window. This provides protection for the window motor. Operation of window circuit takes 3 seconds (FIG. 5).

Once the windows are down this circuit will not repeated window down movement. The circuit board also includes a temperature control circuit (FIG. 7) set for 45 degrees. Temperature sensor is placed on the doorpost (FIG. 14 or 15) just in side the outer skin for this circuit. This circuit will not allow the window circuit to operate when temperature reaches 45 degrees or below providing protection from cold . Also there is a second circuit for extreme heat set for 95 degrees in side of the Vehicle (FIG. 8). T 2 Thremistor is inside the vehicle and is a bypass in case the temperature rises to quickly it also will trigger the horn and light operation as well as operate the window circuit and unlock the doors.

Circuitry for horn, lights are at a pulse rate of 2 seconds on and 2 seconds off (FIG. 4). This is continuous until either the child has been removed or the door has opened or the vehicle has been restarted.

Normal operation of the vehicle is restored when the safety seat circuit has not been triggered.

With exception of supply power and ignition switch power and wiring to and from the windows all other wires are at a ground potential. That is seat wire (FIG. 10) limit switches (FIGS. 13, 14 & 15).

Relay connections to horn & lights are ground connections switched on the circuit board.

The on board light source (FIG. 1) is 6 LEDS light emitting diodes. They indicate the operation of the circuit board. Led 1 shows operation of motion sensor Led 2 indicates that the seat switch has been activated, Led 3 indicates that the system has been armed the first timer sequence has completed. Led 4 shows that the second timer sequence is complete and the system has been triggered. The alarm is on. Led 6 (FIG. 1 & 7) is an indication that temperature of 45 degrees or below has been reached. Led 5 is an indication that excessive heat in vehicle has occurred above 95 degrees.

The Integrated Child Safety Seat Switches & Wiring
Polarity Must Be Observed

Red=Positive, Black=Negative [Wire
The Wiring Harness

A nylon connector (FIG. 11) marked C is wire from vehicle wire harness to nylon connector A this connection travels to the control box. Terminal blocks W 1, 2, 3 & 4 pins 4+ & pin 6− going to the normally closed contacts on circuit board.

Nylon connector B is wire that continues to the window motor pin 1+ & pin 3− from the control unit to nylon connector D contacts at the circuit board are the common contacts FIG. 5&11.
These are to Polarize the Connections

Polarity Must Be Observed.
The Integrated Child Safety Seat

A 1-inch diameter by ⅜ inch thick magnet mounted on each door. FIG. #12, 14 & 15

A 1 inch by ¼ inch diameter proximity switch secured By a rubber grommet and operated by the magnet mounted on the door. FIG. 13, 14 & 15 A miniature long lever switch single pole double throw The connections are C=common pin 2 & NC=normally closed pin 5 terminals are wired to a part of terminal blocks W 1, 2, 3 & 4 (FIG. 17) on the control box one set for each window. This is the limit switch protection. The female connection wired from the control box to the safety seat switches inner terminal. FIG. 10. The male connector is wired to the outer terminal safety seat switch to eliminate false triggering.

The Integrated Child Safety Seat
Control Box & Pressure Switch:

FIG. 10

The pressure switch shown can be placed in any cushion. Toddler, Baby Seat or Cushion. The seat switches are connected in parallel so you can connect as many as needed. Any one of these switches can activate the control unit. Simply slide the pressure switch under the seat padding or in side a cushion. The pressure switches are universal and can be placed in any seating arrangement.

FIGS. 16 & 18 Front View Of Control Box

Light emitting diodes are from left to right. A blue led for a cold temperature alert. Next is a red led for a hot temperature alert. Third is a orange led showing that the alarm circuit is activated. A yellow led shows that the system has been armed. The green led tells that the unit is turned on and a person has been placed in the vehicle. A white or clear led is used to show the motion sensor is active.

THE INTEGRATED CHILD SAFETY SEAT FRONT & REAR PANELS CONNECTIONS for TB 2 a 9 pin connector (FIGS. 17) Pins 1 & 2 are door switch. Pin 4 & 5 safety seat switch. Pin 3 & 6 spares Pin 7 positive 12 volt supply power. Pin 8 ground. Pin 9 switched ignition 12 volt supply TB 1=A 12 pin connector (FIG. 17). Pins 1 & 2 are a pulse to ground for Horn, & Lights.

These terminals connect to the ground side of the vehicle relays (parallel the ground that activates that relay) Pin 3=A continuous ground controlled by relay 4 on the circuit board. This ground lead is connected to the emergency light flasher relay in vehicle. Pin 4 is input from motion detector. Pins 5 is for the cold temperature sensor. Pin 6 is hot temperature sensor. Pin 7 positive supply voltage for the motion sensor. Pin 8 is ground for the detectors. Pin 9 is the door lock pulsed power. Pins 10, 11 & 12=spare connection.
FIG. 17 Connectors W 1, 2, 3 & 4 Relays 5A, 5B, 5C & 5D

Terminal connections for door windows. All windows are connected the same. This will allow placement of window connectors to be universal. Pin 1=a positive lead to window motor starting at the relay common terminal on circuit board positive side. P in 3=a negative lead to window motor starting at the common terminal on circuit board ground side of the same relay. Pins 2 & 5 are for connecting the limit switch one wire to relay ground side the wire to one of the transistors on circuit board to complete the circuit. Pin 4=to provide connection to vehicle wire harness positive side. Pin 6=to provide connection to vehicle wire harness negative side.
Items of the Child Safety Seat

Item #1 Circuit board size 9″ length by 6″ width

Item #2 FIG. 10 seat switch a circuit board with 4 tactical switches mounted on it place inside a cushion or toddler seat or under the padding of the baby car seat plugged into wire harness. You can connect, as many as needed this are parrell circuits. Any one of these switches will activate the alarm system

Item # 3 Relay 1 (FIG. 2) A single pole double throw relay wired to seat switches to supply power for initial timer circuit.

Item # 4 An integrated circuit IC 1-CD 4001 a quad 2 input NOR Gate (FIG. 2) along with resistors/capacitor network set up the first part of the first timer sequence

Item # 5 An integrated circuit IC 2-CD 4001 a quad 2 input NOR Gate (FIG. 2) along with resistors, capacitors one capacitor a large capacitor for a longer duration sets up the second half. This circuit times out in 1 minute 40 seconds.

Item # 6 Q 1 a 2n2222 transistor used as ground circuit controlling relay 3-coil voltage. Q 1 triggered by output of IC 2 through diode 2 at this point a jumper wire connects to LED circuit 3 (FIG. 1) showing system is armed.

Item # 7 Relay 3 A single pole double throw relay that supplies power to the second timer circuit.

Item # 8 Doorpost mounted proximity switches (FIGS. 12, 14 & 15) used in the control circuit of relay 3 (FIG. 2) to allow additional entry and setup time.

Item # 9 Relay # 2 (FIG. 2) A power supply relay a single pole double throw relay triggered by the ignition switch. The supply voltage sent to relay 3 through relay 2 contacts. This allows power only when ignition switch is turned off.

Item # 10 An integrated circuit IC 3-CD 4001 a quad 2 input NOR Gate (FIG. 3) setting up the first half of the second timer sequence on the alarm system along with a resistor/capacitor network.

Item #11 IC 4-CD 4001 a integrated circuit a NOR Gate (FIG. 3) an its accompanying resistor capacitor network that sets up the final count down of 20 seconds. Through a diode that triggers Q 2.

Item # 12 Q 2 A 2n2222 transistor used in a ground circuit for relay 4 also at this Point a jumper wire also to LED 4 (FIG. 1) showing system has been triggered.

Item #13 Relay 4 A double pole double throw relay. One half is used to ground the vehicles emergency flasher relay apart of the automotive factory wiring, the second half is to supply power to the last three circuit timers

Item # 14 IC 5 A LM555 timer (FIG. 4) set as a pulse timer at a rate of 2 seconds on 2 seconds off controlled output for Q3 that signals relay 5 output.

Item # 15 Q 3 A 2n2222 transistor supply's a ground path on relay 5 coil voltage.

Items # 16 Relay 5 a double pole double throw relay that provides grounds for the horn and headlights vehicle relays circuits supplied by factory in automobile

Item # 17—Relay 6 (FIG. 5) A single pole double throw relay a supply path for IC 6 controlled by Q4.

Item # 18 IC 6—LM 555 timer set as a 3 second timer a single shot timer the output feeds 4 transistors that operate the window relays

Items # 19, 20,21 & 22 Q 5, 6, 7 & 8 These 4 transistors operate 4 relays RL 7, 8, 9 &1 0 windows down relays ground side. It is also wired to individual limit switches (FIG. 13, 14 & 15)one for each relay, transistor network.

Items # 23, 24, 25 & 26—4-miniature basic switch a single pole double throw normally closed switch used as limit switches for motor protection (FIGS. 13, 14 & 15). Hard wired to circuit board to interrupt ground path on relay coils stopping relay operation when windows are completely down.

Items# 27, 28, 29 & 30—4 relays double pole double throw (FIG. 5A, 5B, 5C & 5D) used to operate the windows. When not in operation normal vehicle function for windows is restored.

Item # 31 IC 8 CD4001 quad two input NOR gate (FIG. 7) used for a thermal control. Set temperature at 45 degrees, output controlling Q11 & Q12 2n2222 transistor.

Item # 32 T1 thermistor sensor for out side temperature. FIG. 7 & 9

Item #33 Q 11 provides ground for LED 6 (FIG. 1 & 7).

Item #34 Q14 BC557 PNP transistor provides a ground path for the coil of relay 11 (FIG. 8).

Item # 35 IC 9—CD4001 quad two input NOR gate. Set for a temperature of 95 95 degrees part of a bypass circuit for excessive heat. FIG. 8.

Item # 36 T2 thermistor sensor for inside temperature (FIG. 8).

Item # 37 Q 13 a PNP transistor used in ground circuit for LED 5 (FIG. 8)

Item # 38 Relay 11 a single pole double throw relay (FIG. 8) supplies emergency power to IC s 5, 6 & 7 during excessive heat for windows, horn & lights circuits.

Items # 39, 40, 41, 42 & 43 these are light emitting diodes (LEDS) diodes 1, 2, 3, 4 & 5 (FIG. 1)

LED 1 Used to show motion sensor condition LED 2 shows the circuit has been turned on LED 3 alerts that the first alarm sequence is active and ready. LED 4 is the alert showing that the alarm has been triggered. LED 6 alarms the condition of cold a temperature condition. LED 5 alerts excessive heat condition.

Items # 44, 45, 46 & 47—6-position interlocking female connector for windows wire & limit switches (FIG. 17).

Items # 48, 49, 50 & 51—6 position interlocking male connector for wiring to the windows & limit switches all four connector outputs are the same.

Item # 52—12 position interlocking female connector (FIG. 17) wiring from circuit board, 2 terminals for temperature sensors, 1 terminal for emergency flashers, 2 terminals that pulse a ground for horn& headlights, 1 terminal for motion sensor, 1 terminal for door locks, 1 for ground, 1 for +12 supply voltage ,3 spare terminals.

Item # 53—12 position interlocking male connector to wire to the horn, lights, sensors.

Item # 54—9 position interlocking male connector (FIG. 17), 2 outputs spares, 2 outputs for seat switch, 2 outputs for door proximity switch, and 1 terminal for 12 volt power supply DC, 1 terminal for 12 volt ignition switched supply, 1 terminal for chassis ground.

Item # 55—9 position interlocking female connector to terminate wiring for seat switch, door switches, power supplies & ground.

Item #56—Single sided circuit board size 9″ long by 6″wide

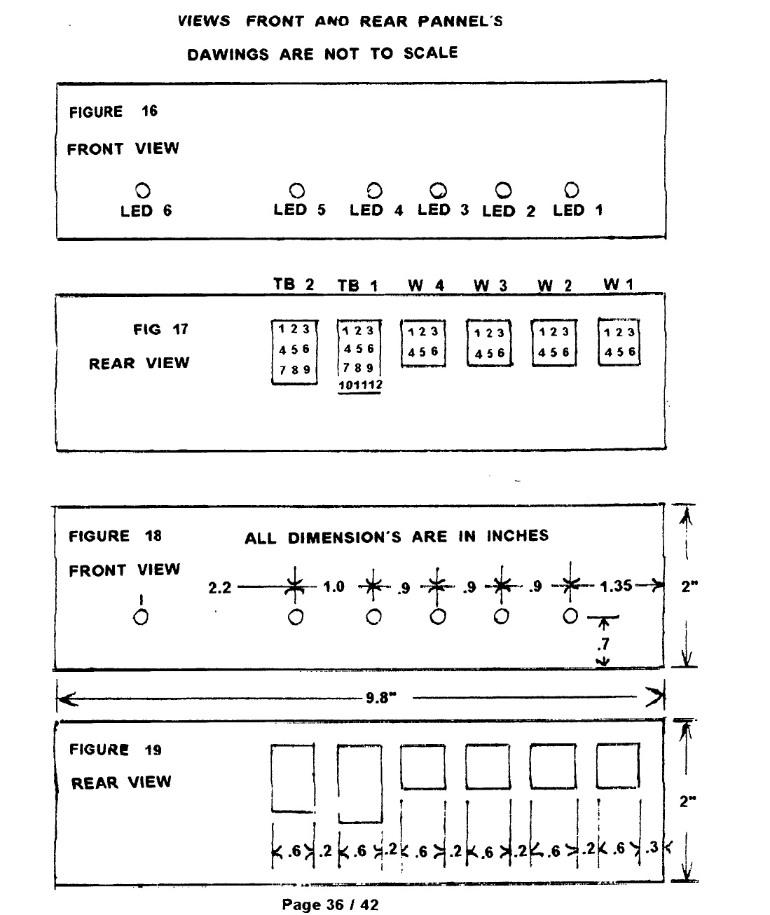

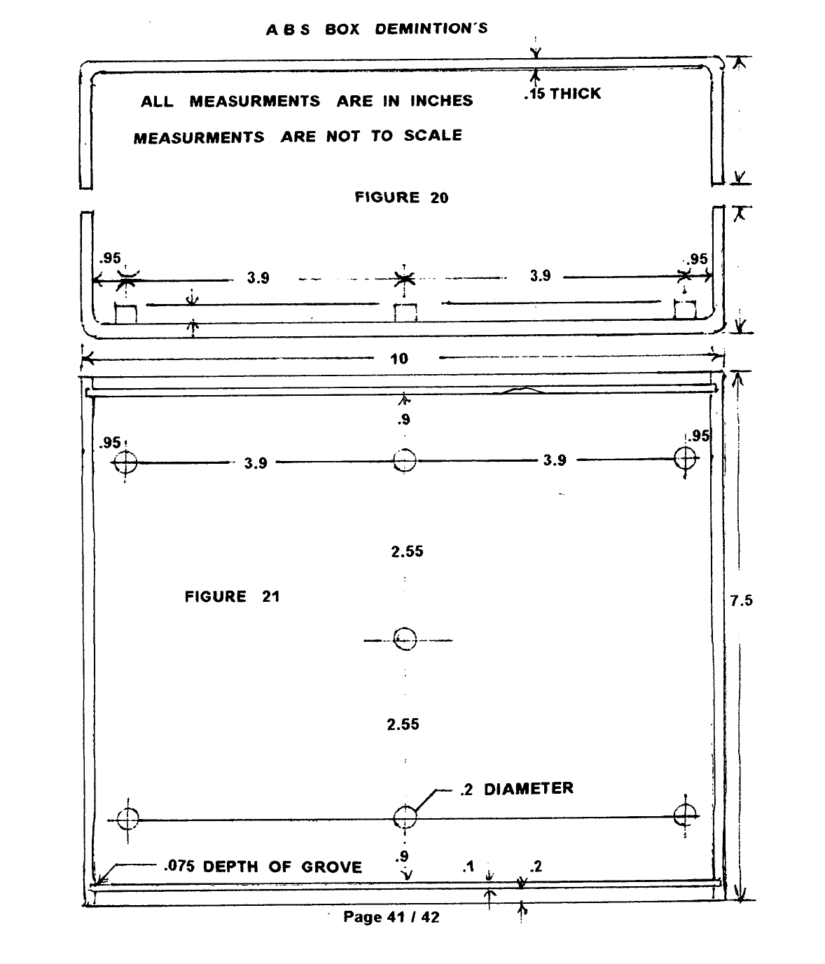

Item# 57—ABS plastic cabinet 2″ in height (FIG. 19 & 20)

Item #58—Proximity switch 1″ in length ¼″ in diameter switch mounted on the doorpost (FIGS. 14 & 15)operated by a magnetic for all four doors to control the on circuit board relays (FIG. 5).

Item #59—magnet 1″ round ¾″ thick installed on each door to operate the magnetic proximity switches

Item#60 Switch pad with tactical switches (FIG. 10) soldered to a single sided circuit board 3″ by 4.5″ that has wire and a male end of a ⅛th phono connector for connecting to wire harness and a smaller circuit board with springs covering over the top of the switches housed in a thin plastic covering used as a pressure switch.

Item # 61—2 remotely mounted circuit boards (FIG. 9) placed in the upper part of the vehicle this is for the heat, cold & motion sensors.

Proximity switches MP201701 Magnet size 1 inch round ¾ thick (FIG. 12).

1. The circuit design and the placement of supplies in the vehicle distinctively differentiate this design from any other, allowing alarms to sound off. Alerting someone in the vehicle is in danger, and allowing to roll down.
